(19) United States
(12) Patent Application Publication
(10) Pub. No.: US 2004/0119174 A1
(43) Pub. Date: Jun. 24, 2004

(54) Method for forming ophthalmic lenses using reusable molds

(76) Inventors: Gregory J. Hofmann, Jacksonville Beach, FL (US); Thomas R. Rooney, Jacksonville, FL (US); Victor Lust, Jacksonville, FL (US); Ture Kindt-Larsen, Holte (DK); Christian Elbek, Virum (DK); Christopher Wildsmith, Jacksonville, FL (US)

Correspondence Address: PHILIP S. JOHNSON, JOHNSON & JOHNSON, ONE JOHNSON & JOHNSON PLAZA, NEW BRUNSWICK, NJ, 08933-7003, US

(21) Appl. No.: 10/323,307

(22) Filed: Dec. 19, 2002

(51) Int. Cl. B29D 11/00

(52) U.S. Cl. 264/1.32; 264/2.5

(57) ABSTRACT

A method for manufacturing ophthalmic lenses using reusable thermoplastic molds is provided. The invention permits the production of a full prescriptive range of lenses while reducing the number of mold inserts required. Further, the method of the invention may be used in a method for the delivery of customized ophthalmic lenses to a lens wearer.

### FIELD OF THE INVENTION

The present invention relates to the manufacture of ophthalmic lenses. In particular, the invention provides a method in which contact or intraocular lenses are produced using a mold or mold half that is reusable.

### BACKGROUND OF THE INVENTION

The use of ophthalmic lenses, including contact lenses, for the correction of ametropia is well known. Production of the lenses using casting or molding requires the use of molds that impart the desired corrective characteristics onto the lens surfaces. In a typical process for the casting or molding of contact lenses, metal inserts are fabricated and subsequently used to produce molds from which lenses will be cast. Once the mold is used to produce a lens, it is discarded. Thus, this process requires maintenance of a large inventory of mold inserts corresponding to each sphere, add, and cylinder power, and combinations thereof to enable production of standard prescriptions. An even larger inventory would need to be maintained if lenses customized to a particular lens wearer were being manufactured. In addition, production of the mold inserts themselves is costly and time consuming.

One method of addressing these disadvantages is disclosed in U.S. Pat. No. 5,782,460 in which a reusable mold or mold half made of quartz, glass, or sapphire is disclosed. However, the use of these molds is disadvantageous in that they are costly to use in producing customized lenses. Additionally, it is difficult to form certain shapes, for example an aspherical surface, using a glass mold. Yet another disadvantage is that these rigid molds are not useful in manufacturing articles from polymeric materials that shrink because the material will pull away from the mold surface causing lens defects.

Therefore, a need exists for a method to produce ophthalmic lenses with a mold that permits reduction of mold insert inventory and which overcomes some or all of the disadvantages of known reusable molds.

### BRIEF DESCRIPTION OF THE DRAWINGS

FIG. 1 is a flow chart of a preferred embodiment of the invention.

### DESCRIPTION OF THE INVENTION AND ITS PREFERRED EMBODIMENTS

The present invention provides reusable molds and methods for manufacturing contact and intraocular lenses using the reusable molds. The invention permits the production of a full prescriptive range of lenses while reducing the number of mold inserts required. Further, the method of the invention may be used for the delivery of customized ophthalmic lenses to a lens wearer.

In one embodiment, the invention provides a method for manufacturing ophthalmic lenses comprising, consisting essentially of, and consisting of: a.) forming a lens mold blank from a polymeric material, the blank having a first and a second surface; and b.) forming a lens mold half from the lens blank by shaping at least one of the first and second surfaces to form an optical quality molding surface. By “ophthalmic lens” is meant a contact or intraocular lens. Preferably, the invention is used in producing contact lenses. By “optical quality” is meant that the surface is sufficiently smooth so that a surface formed by the polymerization of a lens forming material, or lens mold forming material, in contact with the molding surface, is optically acceptable. Preferably, by “optical quality” is meant that the surface has a RMS surface roughness of less than about 50 nm, more preferably less than about 20 nm.

Typically in the molding of contact lenses, a mold half for the front curve, or object-side lens surface, and a complementary mold half for the base curve, or eye-side lens surface, are used. Each mold half has a molding surface suitable for imparting the desired optical characteristics onto the surface of the lens to be formed. By “optical characteristics” is meant one or more of spheric, aspheric, toric, and cylindric curvatures as well as corneal topography, corrections for high order wavefront aberrations of the eye, and the like and combinations thereof. In the process of the invention either or both of the front curve and base curve mold halves are reusable.

In the first step of the method of the invention, a lens mold blank having a first and a second surface is formed. The lens mold blank preferably is of the same shape and size as a mold used in the molding of a lens, but it lacks a molding surface. In the method of the invention, the lens mold blank is formed from a suitable polymeric material, either a thermoplastic or thermoset material, that is compatible with the lens monomer mixture and the process by which the lens monomer mixture will be cured and the lens produced. Preferably, a thermoplastic material is used.

To be compatible with the lens monomer mixture, the mold material must not chemically alter, or itself be chemically altered by, the lens monomer mixture. Additionally, the mold material must be compatible with the conditions by which the lens monomer mixture will be cured. For example, if an ultra-violet light cure is being used, at least one mold half must be permeable to UV light. Further still, the mold material cannot degrade under the conditions used in curing the lens and the subsequent processing steps, such as demolding, in which the mold will used. Finally, the material must be suitable to undergo the second step of the present method, which is formation of a molding surface on the lens blank.

One of ordinary skill in the art will be able to determine the polymeric material to used for the mold blank based on a consideration of the these parameters. Preferably, the lens blank is made from a polystyrene-butadiene, a poly(oxymethylene), a poly(ethirmide), a poly(phenylene sulfide) or the like, and combinations thereof. The lens mold blank is produced by any convenient method including, without limitation, injection molding, grinding, polishing, stamping, or the like, and combinations thereof. Preferably, the lens mold blank is formed by injection molding.

In the second step of the method of the invention the lens mold blank is formed into a lens mold half by shaping at least one of the first and second surfaces of the blank to form an optical quality molding surface. Any convenient method may be used in carrying out this step including, without limitation, diamond point turning, polishing, laser ablation, dry or chemical etching, and the like and combinations thereof. Preferably, the molding surface is formed using diamond point turning

In diamond point turning, the mold blank is fixed so that it can be rotated at desired rotational velocities and so that the blank is not distorted. For example, the blank may be placed into a recessed fixture and secured using a clamp, vacuum chuck or the like. The fixture with the secured blank is then placed into a diamond point turning machine and machined according to the desired design. Typical operating parameters are a diamond radius of about 5 to 500 microns, a spindle speed of about 100 to 300,000 rpms, and a feed rate of about 0.01 to about 500 mm/minute. The depth of the cut for a polymeric blank will be about 50 to 100 microns. Suitable diamond point turning machines are commercially available.

The resulting lens mold half is suitable for use in the production of lenses. In the production of lenses, the mold half is mated with a complementary mold half that itself may be reusable or may be disposable. In a preferred method of forming lenses, a lens-forming material may be deposited on the molding surface of a mold half by any suitable means. The volume of lens-forming material dispensed will be a lens forming amount which is an amount effective to form the desired ophthalmic lens. Typically, the amount of material deposited used will be about 0.01 mg to about 100 g.

Suitable lens-forming materials for contact lenses are any materials useful for forming hard or soft contact lenses. Preferably, the lens-forming material is suitable for forming a soft contact lens. Illustrative materials for formation of soft contact lenses include, without limitation silicone elastomers, silicone-containing macromers including, without limitation, those disclosed in U.S. Pat. Nos. 5,371,147, 5,314,960, and 5,057,578 incorporated in their entireties herein by reference, hydrogels, silicone-containing hydrogels, and the like and combinations thereof. More preferably, the surface is a siloxane, or contains a siloxane functionality, including, without limitation, polydimethyl siloxane macromers, methacryloxypropyl polyalkyl siloxanes, and mixtures thereof, silicone hydrogel or a hydrogel, such as etafilcon A.

In using the molds of the invention to produce intraocular lenses, any suitable intraocular lens material may be used. Illustrative materials for forming intraocular lenses include, without limitation, polymethyl methacrylate, hydroxyethyl methacrylate, inert clear plastics, silicone-based polymers, and the like and combinations thereof.

Once the lens-forming material is deposited into a lens mold half, the mold half and its complementary mold half are assembled and curing of the lens material is carried out. By “complementary” is meant that, when assembled, the two mold halves form a cavity suitable for use in casting the desired lens. Curing of the lens forming material deposited within the mold may be carried out by any means known including, without limitation, thermal, irradiation, chemical, electromagnetic radiation curing and the like and combinations thereof.

Preferably, molding is carried out using ultraviolet light or using the full spectrum of visible light. More specifically, the precise conditions suitable for curing the lens-forming material will depend on the material selected and the lens to be formed.

Polymerization processes for contact and intraocular lenses are well known. For example, suitable processes for forming contact lenses are disclosed in U.S. Pat. No. 5,540,410 incorporated herein in its entirety by reference. More specifically, for formation of contact lenses, a preferred curing condition is to pre-cure the mold assembly using UV light with an intensity of about 2 to about 10 mW/cm². Following the pre-cure, the mold assembly is exposed to UV light of an intensity of about 0 to about 4.0 mW/cm². Suitable wavelengths are about 300 to about 500 nm. The time for the low intensity exposure will depend on the lens-forming material selected, the type and amount of any initiator used, material viscosity and the nature of its reactive groups, and the intensity of the UV light. Both pre-cure and subsequent UV exposure may, and preferably are, carried out as single, continuous exposures. However, the exposures also may be carried out using alternating periods of UV exposure and non-exposure periods. The polymerization steps preferably are carried out at a temperature between about 40 to about 75° C. and atmospheric pressure preferably under a blanket of nitrogen gas. Total cure time is between about 300 to about 500 seconds.

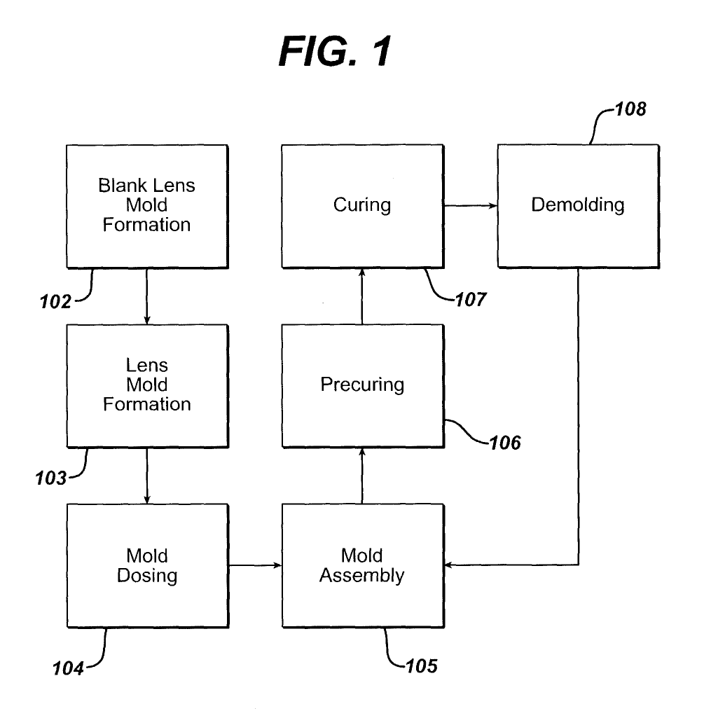

In FIG. 1 is depicted a preferred embodiment of the invention. In this embodiment, the lens mold blank suitable for forming a reusable lens mold half is formed (102). The lens mold half subsequently is formed from the blank (103) by shaping one of the blank's surfaces so as to form a molding surface. The resultant lens mold half preferably is suitable for use in molding a base curve, or eye side curve, of the lens. Lens monomer material is dosed (104), or dispensed, by any convenient means into the front mold half that is complementary to the back curve mold half. The back curve mold half and front curve mold half and assembled (105) to form a mold. In the preferred embodiment, the back curve mold half is made of a material that is relatively more rigid in comparison to that of the front curve. In this embodiment, the back mold curve may be a polyoxymethylene curve and the front curve is typically polypropylene.

Optionally, the lens monomer material undergoes precuring (106) before curing (107) is initiated. Following completion of curing, the newly formed lens is demolded (108) and the reusable base curve mold is returned to the mold assembly step (105) for reuse while the front curve mold is disposed.

A problem unique to the use of two reusable molds is that lens edge formation cannot rely on the back curve of the lens mold cutting off excess monomer. Thus, preferably, one disposable mold half is used with one reusable mold half. In embodiments in which both mold halves are reusable, the lens edge formation may be carried out by any method that ensures a suitable lens edge is formed including, without limitation, using a gasket insert, laser edging the lens after curing to form the lens edge, providing a mask around the cavity of the mold halves to prevent curing of lens material at the edge, and the like and combinations thereof If a gasket is used, the gasket is made from a suitable elastomeric material, or other material, that is capable of deforming when compressed by the edge of one or both mold halves when force is applied to the mold halves. Preferably, the gasket is fitted into a groove placed into at least one of the mold halves at a suitable location.

The present invention may be used in the formation of any type of contact and intraocular lens. However, the invention may find its greatest utility in the production of contact lenses customized for a particular individual. For example, the distortions or aberrations of the individual's eye may be measured using clinical wavefront sensors, such as aberroscopes, Hartmann-Shack devices and mirror arrays capable of measuring these aberrations are commercially available. The wavefront data, or measured aberrations, may be represented by a set of mathematical coefficients, such as Zernike coefficients, that may be used to form the molding surface of the reusable mold. In addition, the molding surface may be made so that it imparts a geometry to a back surface of a contact lens that substantially corresponds with that of the lens wearer's cornea. The corneal topographic data for the lens wearer may be acquired using conventional topographers.

In preferred use of the invention method, a lens wearer's prescription information is determined. By “prescription information” is meant information necessary to correct the low order aberrations of the lens wearer. This information includes, without limitation, sphere, cylinder, axis, add power, and the like, and combinations thereof. The information may be obtained using conventional ocular measuring devices or, and preferably, by use of wavefront sensors. Optionally and preferably, optical data is determined for the lens wearer. “Optical data” means measurement of higher order ocular aberrations. Such data is obtained using wavefront sensors. Finally, optionally and preferably, patient fit data is determined. For contact lenses, such data will include, without limitation, corneal topographic measurements of the lens wearer's cornea. The prescription information, optical data, and patient fit data (collectively, the “order information”) is then sent to the lens manufacturer by any convenient ordering means including, without limitation, telephone, facsimile transmission, internet website, and the like and combinations thereof. In a preferred embodiment, ordering is carried out via the lens manufacturer's internet website by the customer using any means capable of communicating with the lens manufacturer's server system (web server or web site). Suitable means for communicating with the website include, without limitation, a personal computer and modem. Thus, in yet another embodiment the invention provides a method for producing customized ophthalmic lenses comprising, consisting essentially of, and consisting of the steps of: a.) transmitting, by a customer using a computer system, to a lens manufacturer's server system lens order information; b.) manufacturing by the lens manufacturer the customized lenses using a mold formed by the steps comprising, consisting essentially of, and consisting of forming at least one half of the lens mold from a polymeric material blank wherein at least one surface of the blank is shaped to form an optical quality molding surface; and c.) delivering by the lens manufacturer directly to the lens wearer.

What is claimed is:

1. A method for manufacturing ophthalmic lenses, comprising: a.) forming a lens mold blank from a polymeric material, the blank having a first and a second surface; and b.) forming a lens mold half from the lens blank by shaping at least one of the first and second surfaces to form an optical quality molding surface.

2. The method of claim 1, wherein the lens is a contact lens.

3. The method of claim 3, wherein the mold blank comprises, a polystyrenebutadiene a poly(oxymethylene), a poly(ethirmide), a poly(phenylene sulfide) or combinations thereof.

4. The method of claim 3, wherein the forming step b.) is carried out using diamond point turning, polishing, laser ablation, dry or chemical etching or combinations thereof.

5. The method of claim 3, wherein the forming step b.) is carried out using diamond point turning

6. The method of claim 2, further comprising using the optical quality molding surface to form a base curve of the contact lens.

7. A method for manufacturing contact lenses, comprising providing a first and a second mold half, wherein at least one of the mold halves are formed by method comprising: a.) forming a lens mold blank from a polymeric material, the blank having a first and a second surface; and b.) forming a lens mold half from the lens blank by shaping at least one of the first and second surfaces to form an optical quality molding surface.

8. The method of claim 7, wherein the first mold half is suitable for molding a front curve of the lens and the second mold half is suitable for molding a back curve of the lens.

9. The method of claim 8, wherein the first mold half comprises polypropylene and the second mold half comprises polyoxymethylene.

10. The method of claim 8, wherein the first mold half comprises polystyrene and the second mold half comprises polyethirmide.

11. The method of claim 8, wherein the first and the second mold half comprise polyoxymethylene.

12. An ophthalmic lens mold, comprising a first and a second mold half, wherein at least one of the mold halves are formed by: a.) forming a lens mold blank from a polymeric material, the blank having a first and a second surface; and b.) forming a lens mold half from the lens blank by shaping at least one of the first and second surfaces to form an optical quality molding surface.

13. The method of claim 12, wherein the first mold half is suitable for molding a front curve of the lens and the second mold half is suitable for molding a back curve of the lens.

14. The method of claim 12, wherein the first mold half comprises polypropylene and the second mold half comprises polyoxymethylene.

15. The method of claim 12, wherein the first and the second mold half comprise polyoxymethylene.

16. A method for producing customized ophthalmic lenses, comprising the steps of: a.) transmitting, by a customer using a computer system, to a lens manufacturer's server system lens order information; b.) manufacturing by the lens manufacturer the customized lenses using a mold formed by the steps comprising forming at least one half of the lens mold from a polymeric material blank wherein at least one surface of the blank is shaped to form an optical quality molding surface; and c.) delivering by the lens manufacturer directly to the lens wearer.
